(19) United States
(12) Patent Application Publication
(10) Pub. No.: US 2013/0222295 A1
(43) Pub. Date: Aug. 29, 2013

(54) MOBILE TERMINAL TO OPERATE BASED ON TOUCH INPUT, AND OPERATING METHOD THEREOF

(71) Applicant: Pantech Co., Ltd., (US)

(72) Inventors: Hyeng-Keun LIM, Seoul (KR); Sung-Yeon Moon, Seoul (KR); Won Seok Park, Seoul (KR); Jun-Hyuk Seo, Seoul (KR)

(73) Assignee: Pantech Co., Ltd., Seoul (KR)

(21) Appl. No.: 13/728,482

(22) Filed: Dec. 27, 2012

(30) Foreign Application Priority Data
Feb. 23, 2012 (KR) 10-2012-0018504
Feb. 23, 2012 (KR) 10-2012-0018506

(51) Int. Cl. G06F 3/041

(52) U.S. Cl. CPC G06F 3/041
USPC 345/173

(57) ABSTRACT

A mobile terminal includes a touch panel to receive touch gestures to power on and power off the mobile terminal. The touch panel may also receive touch gestures to adjust the volume or place the mobile terminal in a hold state. The touch panel is separate from a touch screen which receives inputs in a power on state. The touch panel may include a first input area which may receive a periodic signal in a power off mode, a touch sleep mode, and a hold mode. If in the power off mode, the touch sleep mode, or the hold mode, a touch gesture is received in the first input area, other input areas may be powered on to receive a signal.

### CROSS-REFERENCE TO RELATED APPLICATION

This application claims priority from and the benefit under 35 U.S.C. §119(a) of Korean Patent Application No. 10-2012-0018504 and Korean Patent Application No. 10-2012-0018506, each filed on Feb. 23, 2012, which are incorporated herein by references for all purposes as if fully set forth herein.

### BACKGROUND

1. Field

The following description relates to a mobile terminal, and more particularly, to a mobile terminal operating based on a touch input, and an operating method thereof.

2. Discussion of the Background

In order to power on a general mobile terminal, a user has to use a power on key installed on the outer surface of the mobile terminal. Generally, the power on key is a tact switch or a dome switch mounted on a Flexible Printed Circuit Board (FPCB). If the user presses the power on key to supply power to the mobile terminal, the power on key may function as an event input key for executing an End/Hold function, etc., of the mobile terminal.

The mobile terminal also generally has volume keys separately installed on the outer surface of the mobile terminal. The volume keys may be tact switches, dome switches, jog keys, etc. As such, the power on key and volume keys are configured as mechanical switches, and may transmit an event, such as power on/off, hold, and volume up/down, to the central processing unit (CPU) of the mobile terminal to execute the event according to user input operation received through the power on key and volume keys. However, mechanical switches have instrumental and design limitations, and furthermore, the mechanical switches may deteriorate in reliability as they are used for a long time.

### SUMMARY

The following description relates to a mobile terminal of operating based on a touch input, having an improved design and enhanced reliability, and an operating method of the mobile terminal.

Other features and aspects will be apparent from the following detailed description, the drawings, and the claims.

Additional features of the invention will be set forth in the description which follows, and in part will be apparent from the description, or may be learned by practice of the invention.

An exemplary embodiment of the present invention discloses a mobile terminal, including: a touch screen to receive inputs in a power on state; a touch panel to detect a touch gesture, the touch panel being separate from the touch screen; and a touch sensing unit to perform at least one of power on the mobile terminal, power off the mobile terminal, adjust a volume of the mobile terminal, hold on the mobile terminal, or hold off the mobile terminal according to the touch gesture and a mode of the mobile terminal.

An exemplary embodiment of the present invention also discloses a method of operating a mobile terminal including a touch panel and a touch screen, the method including: activating a first input area of the touch panel to receive a first touch gesture, the touch panel being separate from the touch screen; activating a second input area of the touch panel to receive a second touch gesture if the first touch gesture is received; determining if a second touch gesture is received; and generating a power supply start control signal to power on or power off the mobile terminal according to the first touch gesture and the second touch gesture.

An exemplary embodiment of the present invention also discloses a method of operating a mobile terminal including a touch panel, the method including: receiving a first touch gesture in the touch panel; determining whether to power on the mobile terminal according to the first touch gesture and a mode of the mobile terminal; and generating a signal to provide power to the mobile terminal according to the determination.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of a mobile terminal operating based on a touch input according to an exemplary embodiment of the present invention.

FIG. 2 is a diagram of a touch sensing unit of the mobile terminal according to an exemplary embodiment of the present invention.

FIG. 3 illustrates a touch input to control power and to control hold according to an exemplary embodiment of the present invention.

FIG. 4 is a timing diagram illustrating a signal pulse of the touch sensing unit according to an exemplary embodiment of the present invention.

FIG. 5 is a timing diagram illustrating a signal pulse of the touch sensing unit according to an exemplary embodiment of the present invention.

FIG. 6 illustrates a touch inputs to control volume according to an exemplary embodiment of the present invention.

FIG. 7 illustrates a touch inputs to control volume according to an exemplary embodiment of the present invention.

FIG. 8 is a timing diagram illustrating user input interrupt signal pulses of a touch sensing unit according to an exemplary embodiment of the present invention.

FIG. 9 illustrates a state model of a mobile terminal according to an exemplary embodiment of the present invention.

FIG. 10 is a flowchart of a method for operating a mobile terminal according to an exemplary embodiment of the present invention.

FIG. 11 is a timing diagram of waveforms of activation signals to sense a touch according to an exemplary embodiment of the present invention.

FIG. 12 is a timing diagram of waveforms of activation signals to sense a touch according to an exemplary embodiment of the present invention.

FIG. 13 is a timing diagram of waveforms of activation signals according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

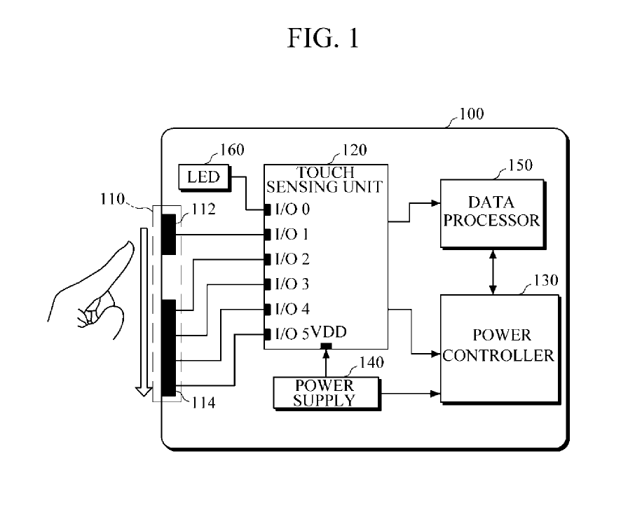

FIG. 1 is a diagram of a mobile terminal operating based on a touch input according to an exemplary embodiment of the present invention.

Referring to FIG. 1, a mobile terminal 100 includes a touch panel 110, a touch sensing unit 120, a power controller 130, a power supply 140, a data processor 150, and a light emitting diode (LED) 160. The mobile terminal 100 may be a mobile terminal, such as, a mobile phone, a MP3 player, a smart phone, a personal computer, a tablet computer, etc. The mobile terminal 100 may further include a touch screen that receives a user input to control an application in a power on state and to display the execution results of the application according to the user input, various communication modules, such as, a GPS receiver, an antenna, etc., a memory, etc. (not shown in FIG. 1) The touch panel 110 may have a mechanical structure of a touch-based switch module, instead of a mechanical structure of a switch module configured with a power key, a hold key, and volume keys.

The touch panel 110 may be installed separately from a general touch screen that may be used to control operations of various applications of the mobile terminal 100, and may operate independently from the touch screen. The touch panel 110 may be activated or deactivated under the control of the touch sensing unit 120. The touch panel 110 may include a first input area 112 and a second input area 114. The touch panel 110 may receive a touch input or gesture in the first input area 112 and/or the second input area 114 to generate a touch signal corresponding to the touch input or gesture. In an example, at least one of the first input area 112 and the second input area 114 may be a touch input area. The touch gesture may refer to touch motion, such as a touch and drag motion or a touch and flick motion, but is not limited thereto.

The first input area 112 may include at least one touch sensor that may receive one or more touch inputs. The second input area 114 may include a plurality of touch sensors that may receive a plurality of touch inputs. The touch sensors included in the first input area 112 and the second input area 114 may be any type of touch sensors, such as, capacitive touch sensors, resistive touch sensors, pressure sensors, etc.

The first input area 112 and the second input area 114 may be configured on the same Flexible Printed Circuit Board (FPCB) or on different FPCBs. FIG. 1 illustrates the first input area 112 and second input area 114 are disposed on the left side of the mobile terminal 100, however, aspects of the present invention are not limited thereto and the first input area 112 and second input area 114 may be disposed on other areas of the mobile terminal 100. For example, the first input area 112 may be disposed on an upper part of the mobile terminal 100 and the second input area 114 may be disposed on a left part or a right part of the mobile terminal 100, i.e., the first input area 112 may be disposed on a top side of the mobile terminal 100 and the second input area 114 may be disposed on an adjacent left or right side of the mobile terminal 100. The first input area 112 may be disposed on the left part or the right part of the mobile terminal 100 and the second input area 114 may be disposed on the backside of the mobile terminal 100, i.e., the first input area 112 may be disposed on a left or right side of the mobile terminal 100, and the second input area 114 may be disposed on the back of the mobile terminal 100. In other words, the first input area 112 may be disposed on one side or surface of the mobile terminal 100, and the second input area 114 may be disposed on the same one side or surface or on an adjacent side or surface of the mobile terminal 100.

If a user's gesture of touching the first input area 112 is sensed, the mobile terminal 100 may be powered on or powered off, however, aspects of the present invention are not limited thereto, and the mobile terminal 100 may perform another function, such as, mode conversion, for example, conversion into a hold on mode. If a user's gesture of touching the second input area 114 is sensed, the mobile terminal 100 may perform volume control, however, aspects of the present invention are not limited thereto, and the mobile terminal 100 may perform turning the page, etc. according to an application execution state of the mobile terminal 100.

If the user's gesture of touching the first input area 112 and second input area 114 is received, a touch sensed signal is generated and transferred to the touch sensing unit 120.

The touch sensing unit 120 is connected to the power supply 140 which may supply current to the entire or a part of the touch panel 110. The touch sensing unit 120 may supply current to activate or deactivate the entire or the part of the touch panel 110, and control the operation of the touch panel 110. The touch sensing unit 120 may receive a touch sensed signal generated according to a touch gesture received on the touch panel 110, generate control signals in response to the touch sensed signal, and transfer the control signals to the power controller 130 and the data processor 150. The control signal that is transferred from the touch sensing unit 120 to the power controller 130 may be referred to as a power control signal, and the control signal transferred from the touch sensing unit 120 to the data processor 150 may be referred to as a user input interrupt signal.

The touch sensing unit 120 may include a plurality of input/output ports (“I/O”) I/O 0, I/O 1, I/O 2, I/O 3, I/O 4, and I/O 5 to receive a plurality of touch sensed signals. As illustrated in FIG. 1, the I/O 1 may be connected to the first input area 112, and the remaining input/output ports, i.e., I/O 2, I/O 3, I/O 4, and I/O 5, may be connected to the second input area 114. If the first input area 112 includes a plurality of touch sensors, the touch sensing unit 120 may include a plurality of input/output ports that are connected to the plurality of touch sensors of the first input area 112.

The touch sensing unit 120 may generate a power control signal according to a state of the mobile terminal 100 or according to a touch sensed signal generated in response to a sensed touch gesture, and may provide the power control signal to the power controller 130. The power control signal may be referred to as a PWR signal. If a user input interrupt signal is transferred to the data processor 150 according to a touch sensed signal generated in response to a sensed touch gesture, the touch sensing unit 120 may perform data reception/transmission with the data processor 150 through a database, such as I2C.

The power controller 130 may control the power supply 140 to supply power to the modules of the mobile terminal 100 including the data processor 150. The power controller 130 may start or stop supplying power to the mobile terminal 100 or control power that is supplied to the mobile terminal 100, according to a power control signal.

The power control signal that is transferred from the touch sensing unit 120 to the power controller 130 may have various types of waveforms according to a state of the mobile terminal 100 or according to a touch sensed signal generated in response to a sensed touch gesture. The power control signal may include a power supply start control signal to instruct the power controller 130 to power on the mobile terminal 100 and a power supply stop control signal to instruct the power controller 130 to power off the mobile terminal 100. A hold on state may refer to a state in which the mobile terminal 100 does not operate in response to a received touch gesture. The power control signal may include a hold on control signal to instruct the power controller 130 to hold on the mobile terminal 100, and a hold off control signal to instruct the power controller 130 to return the hold on state of the mobile terminal to the power on state. If receiving a power supply start control signal, the power controller 130 may supply power to the mobile terminal 100 to perform power control according to an active mode in which the mobile terminal 100 operates normally. If receiving a power supply stop control signal, the power controller 130 may stop supplying power to the mobile terminal 100. If receiving a hold on control signal, the power controller 130 may hold on the mobile terminal 100 to reduce power being supplied to modules that do not operate, for example, a touch screen. If receiving a hold off control signal, the power controller 130 may perform power control according to the active mode in which the mobile terminal 100 operates normally.

If a touch sensed signal is generated when the mobile terminal 100 is in a power off state, a power supply start control signal may be generated. If a touch sensed signal is generated when the mobile terminal 100 is in a power on state, a user input interrupt signal may be generated and transferred to the data processor 150.

The data processor 150 may run an application to operate the mobile terminal 100. If the power controller 130 receives a power supply start control signal, the data processor 150 may receive power from the power controller 130 to operate the mobile terminal 100.

If the mobile terminal 100 is powered off, the touch sensing unit 120 may activate the first input area 112 and deactivate the second input area 114 to reduce power consumption when the mobile terminal 100 is in the power off state. If a touch sensed signal generated by sensing a touch onto the first input area 112 is maintained longer than a first time interval, the touch sensing unit 120 may activate the second input area 114. If a drag touch sensed signal is generated according to a drag touch onto the second input area 114, the touch sensing unit 120 may generate a power supply start control signal to supply power to the mobile terminal 100.

The touch sensing unit 120 may supply power to the LED 160 and the LED 160 may emit light. The emitted light may visually inform the user that the second input area 114 has been activated. Although an LED is illustrated, exemplary embodiments are not limited thereto and the mobile terminal 100 may include different kinds of light-emitting device or audio output devices may be used instead of the LED 160.

If a touch gesture received on the second input area 114 is sensed when the mobile terminal 100 is in the power on state, the touch sensing unit 120 may transfer a user input interrupt signal corresponding to the touch gesture to the data processor 150, and the data processor 150 may control an application being executed according to the user input interrupt signal.

The power supply 140 may be a fixed or a removable power source, such as, a battery, a capacitor, etc., and may be configured to be charged using an external power supply.

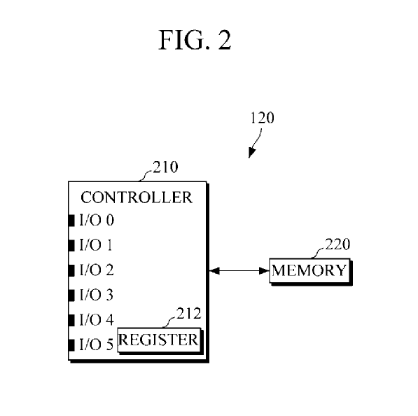

FIG. 2 is a diagram of a touch sensing unit of the mobile terminal according to an exemplary embodiment of the present invention. Although FIG. 2 will be described with reference to FIG. 1, aspects of the exemplary embodiments are not limited thereto.

Referring to FIG. 1 and FIG. 2, the touch sensing unit 120 may include a controller 210 and a memory 220. The controller 210 may perform the operation of the touch sensing unit 120 based on data stored in the memory 220. The controller 210 may run an algorithm for recognizing a touch input or a touch gesture onto the touch pad 110.

The controller 210 may activate or deactivates the I/O 0, the I/O 1, the I/O 2, the I/O 3, the I/O 4, and the I/O 5 to control the touch panel 110. If the controller 210 receives a plurality of touch sensed signals when the mobile terminal 100 is in the power off state, the controller 210 generates a power supply start control signal to supply power to the mobile terminal 100. If the controller 210 receives a plurality of touch sensed signals when the mobile terminal 100 is in the power on state, the controller 210 may generate a user input interrupt signal and may transfer it to the data processor 150.

The controller 210 may include a register 212 which the data processor 150 may access. The register 212 may include a first address in which state information indicating an operation mode of the mobile terminal 100 may be written. As the mobile terminal 100 enters each operation mode, the data processor 150 may write state information indicating the corresponding operation mode as a first register value in the first address of the register 212. The controller 210 may deactivate a part of the touch pad 110 or change a scanning time interval at which a touch input onto the touch pad 110 is sensed, according to the first register value written in the register 212.

The controller 210 may write gesture state information indicating a touch gesture onto the touch panel 110, as a second register value, in a second address of the register 212. For example, the controller 210 may recognize a touch gesture received on the second input area 114, and may write a second register value representing a drag direction in the second address of the register 212. If the data processor 150 receives a user input interrupt signal, the data processor 150 may accesses the second address of the register 212 to read a second register value corresponding to gesture state information, and may control the operation of an application according to a touch gesture based on the user input interrupt signal and the gesture state information.

The second register value may be information to identify a volume up gesture and a volume down gesture. The second register value may include first gesture information corresponding to the volume up gesture and second gesture information corresponding to the volume down gesture. The user input interrupt signal may include information regarding a time interval for which a drag gesture is maintained on the second input area 114.

If the controller 210 senses a touch gesture input and determines that the touch gesture input satisfies at least one wrong operation condition, the controller 210 may ignore the touch gesture input. If the controller 210 determines that the touch gesture input does not satisfy a wrong operation condition, the controller 210 may generate a power control signal for the touch gesture input, transfer the power control signal to the power controller 130, and transfer a user input interrupt signal according to the touch gesture input to the data processor 150. A wrong operation condition may be set for each reference touch gesture that may be recognized according to the state of the mobile terminal 100.

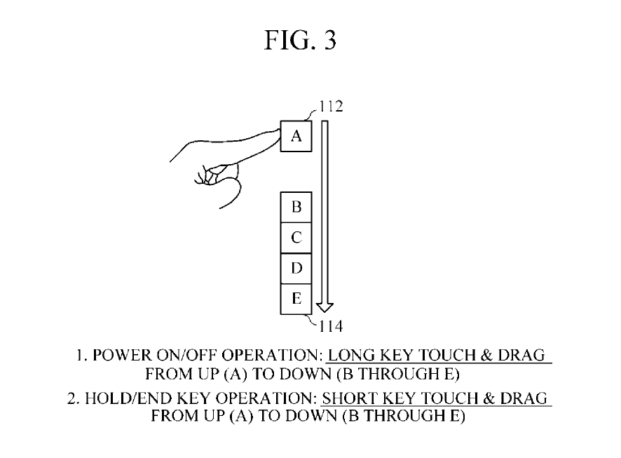

FIG. 3 illustrates a touch input to control power and to control a hold state according to an exemplary embodiment of the present invention.

As described above, referring to FIG. 1 and FIG. 3, the touch pad 110 includes the first input area 112 and second input area 114. FIG. 3, the first input area 112 includes a single touch sensor A and the second input area 114 includes a plurality of touch sensors: touch sensor B, touch sensor C, touch sensor D, and touch sensor E. The touch sensor B, the touch sensor C, the touch sensor D, and the touch sensor E of the second input area 114 may be arranged in a line to sense a drag gesture, and the arrangement direction of the touch sensor B, the touch sensor C, the touch sensor D, and the touch sensor E may be a vertical direction as illustrated in FIG. 3, a horizontal direction, or a diagonal direction.

A power on/off gesture input with respect to the mobile terminal 100 may be a “Long Key Touch & Drag” input of sequentially dragging the touch sensor B, the touch sensor C, the touch sensor D, and the touch sensor E of the second input area 114 after pressing or touching the touch sensor A longer than a first time interval.

In more detail, when the mobile terminal 100 is in the power off state, the touch sensor A may be activated while the remaining other touch sensors, including the touch sensor B, the touch sensor C, the touch sensor D, and the touch sensor E may be inactive. If the touch sensor A senses a touch input being maintained on the first input area 112 longer than the first reference time period, the touch sensor B, the touch sensor C, the touch sensor D, and the touch sensor E of the second input area 114 may be activated. Further, the mobile terminal 100 may turn on the LED 160 to inform a user that the second input area 114 has been activated. Then if the touch sensor B, the touch sensor C, the touch sensor D, and the touch sensor E sense a touch in a dragging motion, power may be supplied to one or more individual operation modules of the mobile terminal 100 so that the mobile terminal 100 may be powered on. If a “Long Key Touch & Drag” type of touch input or gesture is sensed when the mobile terminal 100 is in the power on state, the mobile terminal 100 may be powered off. However, aspects of the invention are not limited thereto, such that at least one of the touch sensor B, touch sensor C, touch sensor D, and touch sensor E may receive a touch input different than a dragging motion. For example, the respective touch sensors may sense a touch within a predetermined period of time after touch sensor initially senses a touch input. Further, various modules may be powered on by operating select touch sensors within the touch sensor B, touch sensor C, touch sensor D, and touch sensor E. Accordingly, various control operations may be performed by providing a touch input on various combinations of touch sensors.

The touch sensing unit 120 may determine whether a touch input satisfies wrong operation conditions for “Long Key Touch & Drag,” in order to detect a wrong operation related to “Long Key Touch & Drag.” For example, a first wrong operation condition for “Long Key Touch & Drag” may be a condition in which touch sensed signals are sensed by the touch sensor C, the touch sensor D, and the touch sensor E if a touch sensed signal is sensed according to pressing or touching of the touch sensor A, a second wrong operation condition may be a condition in which touch sensed signals are sensed by the touch sensor A, the touch sensor B, and the touch sensor C if a touch sensed signal is sensed according to pressing or touching of the touch sensor E, and a third wrong operation condition may be a condition in which touch sensed signals are simultaneously sensed by three or more touch sensors. If a “Long Key Touch & Drag” gesture input is recognized, the touch sensing unit 120 may determine whether the “Long Key Touch & Drag” gesture input satisfies one of the first wrong operation condition, the second wrong operation condition, and the third wrong operation condition. If the “Long Key Touch & Drag” gesture input does not satisfy the first wrong operation condition, the second wrong operation condition, and the third wrong operation condition, the touch sensing unit 120 may generate a power control signal and a user input interrupt signal according to the “Long Key Touch & Drag” gesture. If the “Long Key Touch & Drag” gesture input satisfies one of the first wrong operation condition, the second wrong operation condition, and the third wrong operation condition, the touch sensing unit 120 may ignore the “Long Key Touch & Drag” gesture input.

A hold on/off gesture input with respect to the mobile terminal 100 may be a “Short Key Touch & Drag” input of sequentially dragging the touch sensor B, the touch sensor C, the touch sensor D and the touch sensor E of the second input area 114 after pressing or touching the touch sensor A for a period shorter than the first time interval. If a “Short Key Touch & Drag” gesture is recognized when the mobile terminal 100 is in the power on state, the mobile terminal 100 may enter a hold on state in which touch input onto the touch screen (not shown) of the mobile terminal 100 may not be processed, and if a “Short Key Touch & Drag” gesture is recognized when the mobile terminal 100 is in the hold on state, the mobile terminal may enter a hold off state (i.e., an active state) in which the mobile terminal 100 operates normally.

The touch sensing unit 120 may determine whether a touch input satisfies the wrong operation conditions for “Short Key Touch & Drag,” in order to detect a wrong operation related to “Short Key Touch & Drag.” The wrong operation conditions for “Short Key Touch & Drag” may be the same as the wrong operation condition for “Long Key Touch & Drag,” or may differ therefrom.

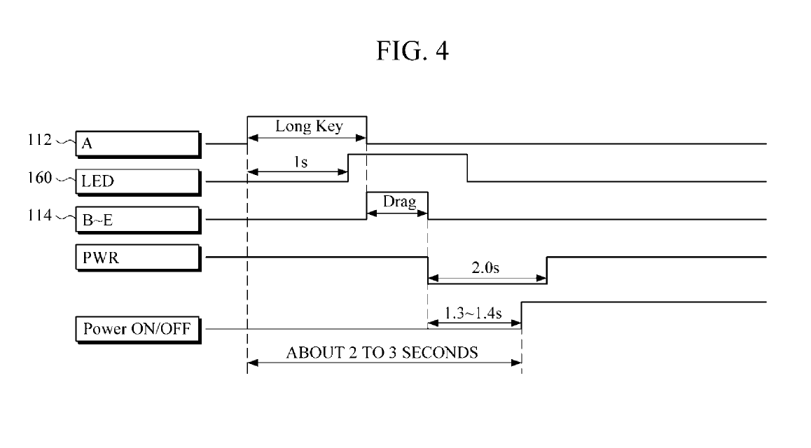

FIG. 4 is a timing diagram illustrating a signal pulse of a touch sensing unit according to an exemplary embodiment of the present invention. FIG. 4 illustrates a signal pulse to control power on the mobile terminal 100. Although FIG. 4 will be described with reference to FIG. 1, aspects of the exemplary embodiments are not limited thereto.

Referring to FIG. 1 and FIG. 4, if the first input area 112 is pressed or touched longer than a first time interval (for example, one second) the touch sensor A senses a long key input. If the mobile terminal 100 is in the power off state and the long key input is sensed, the touch sensing unit 120 may turn on the LED 160 to inform a user that a long key has been input to the first input area 112. If the touch sensor B, the touch sensor C, the touch sensor D, and the touch sensor E of the second input area 114 are activated and a drag gesture is sensed by the touch sensor B, the touch sensor C, the touch sensor D, and the touch sensor E, the touch sensing unit 120 may supply a power supply start control signal as a power control signal PWR to the power controller 130 such that the mobile terminal 100 is powered on. The power control signal PWR may have a first waveform having signal fluctuation of about 2 seconds, as illustrated in FIG. 4. In FIG. 4, it may take between 2 and 3 seconds from the moment the long key input is sensed to the powering on of the mobile terminal 100.

If a “Long Key Touch & Drag” gesture is sensed when the mobile terminal 100 is in the power on state, the touch sensing unit 120 may supply a power supply stop control signal to the power controller 130 so that the mobile terminal 100 is powered off. The power supply stop control signal may have the same waveform as the power supply start control signal, but is not limited thereto.

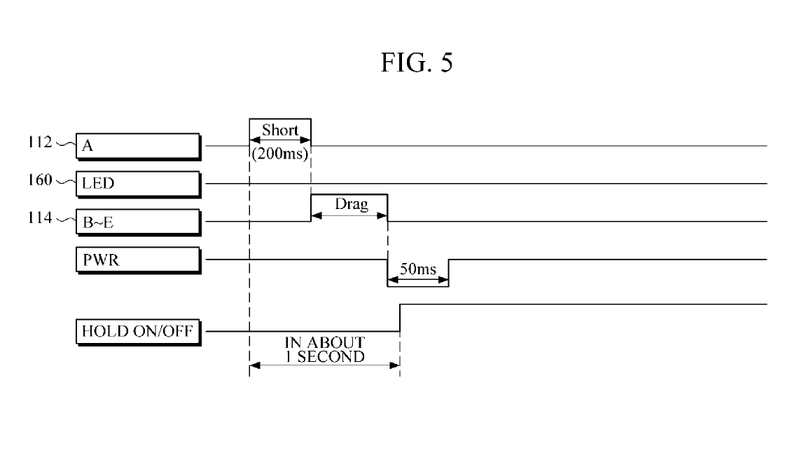

FIG. 5 is a timing diagram illustrating a signal pulse of the touch sensing unit according to an exemplary embodiment of the present invention. Although FIG. 5 will be described with reference to FIG. 1, aspects of the exemplary embodiments are not limited thereto.

Referring to FIG. 1 and FIG. 5, when the mobile terminal 100 is in the power on s state, if the first input area 112 is pressed or touched for a time interval shorter than the first time interval (for example, one second), for example, for 200 ms, the touch sensor A senses a short key input. If a drag gesture is sensed by the touch sensor B, the touch sensor C, the touch sensor D, and the touch sensor E of the second input area 114, the touch sensing unit 120 may supply a hold on control signal as a power control signal PWR to the power controller 130 such that the mobile terminal 100 enters a hold on state to prevent power from being supplied to some parts of the mobile terminal 100 or to supply an adjusted power level to the parts of the mobile terminal. Accordingly, the parts of the mobile terminal 100 may be deactivated or placed in a hibernation state. The hold on control signal may have a second waveform having a signal fluctuation, for example of about 50 ms, as illustrated in FIG. 5. In FIG. 5, it may take about one second from the moment the short key input is sensed until the mobile terminal 100 enters the hold on state.

If “Short Key Touch & Drag” gesture is sensed when the mobile terminal 100 is in the hold on state, the touch sensing unit 120 may supply a hold off control signal to the power controller 130 such that the mobile terminal 100 is powered off. The hold off control signal may have the same waveform as the hold on control signal, but is not limited thereto.

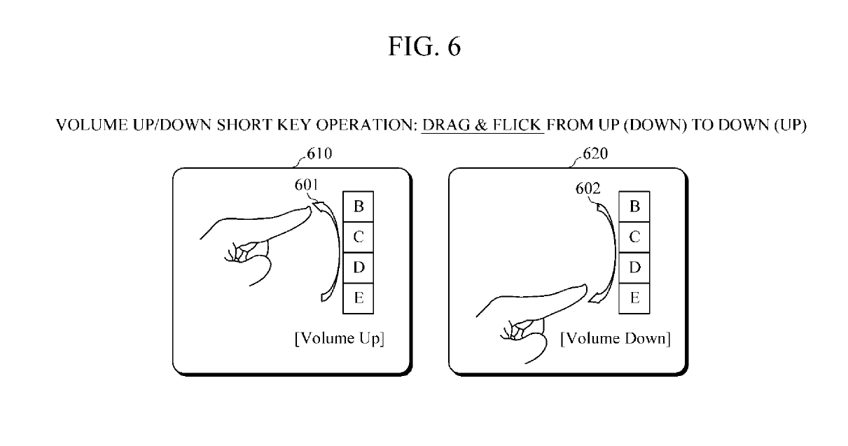

FIG. 6 illustrates a touch input to control volume according to an exemplary embodiment of the present invention. Although FIG. 6 will be described with reference to FIG. 1, aspects of the exemplary embodiments are not limited thereto.

When the mobile terminal 100 is in the power on state, a gesture of dragging the touch sensor B, the touch sensor C, the touch sensor D, and the touch sensor E of the second input area 114 may be classified according to a time interval for which a touch sensed signal sensed by the touch sensor at which the drag gesture is terminated is maintained, and according to the direction of the drag gesture. For example, the touch sensor E may be the touch sensor on which the drag gesture is terminated, and the time interval may correspond to a time interval in which a change in capacitance is maintained if a capacitive touch sensor is used. The time interval for which the touch sensed signal sensed by the touch sensor at which the drag gesture is terminated is maintained may be used as a dragging time by the data processor 150.

If a change in capacitance of the touch sensor at which a drag gesture is terminated is maintained shorter than a second time interval, the drag gesture may be classified into a volume short key gesture. If a change in capacitance of the touch sensor at which a drag gesture is terminated is maintained longer than the second time interval, the drag gesture may be classified into a volume long key gesture. If the touch sensor B, the touch sensor C, the touch sensor D, and the touch sensor E are aligned vertically in this order, and if a drag gesture from down to up (i.e., the direction from the touch sensor E to the touch sensor B) is sensed, the drag gesture may be classified into a volume up key gesture. If another drag gesture from up to down (i.e., the direction from the touch sensor B to the touch sensor E) is sensed, the drag gesture may be classified into a volume down key gesture.

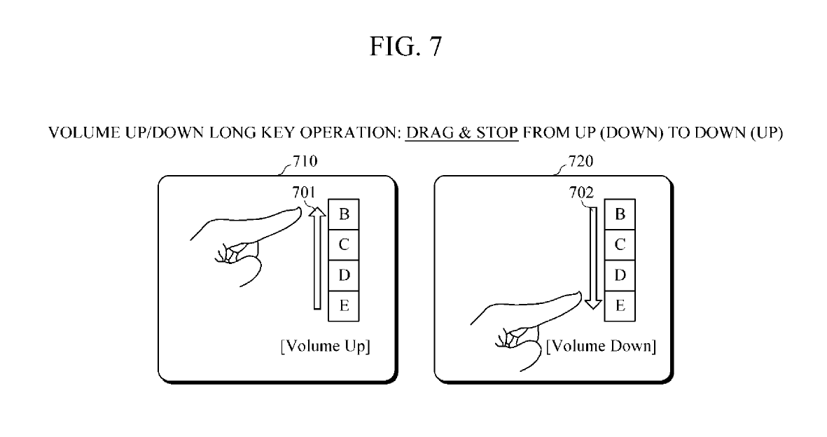

A volume up/down short key gesture may be referred to as a “Drag & Flick” gesture and is illustrated in FIG. 6. A volume up/down long key gesture may be referred to as a “Drag & Stop” gesture and is illustrated in FIG. 7.

Referring to the left part 610 of FIG. 6, if a “Drag & Flick” gesture 601 of dragging an object (i.e., finger, stylus, etc.) against the touch sensor B, the touch sensor C, the touch sensor D, and the touch sensor E of the second input area 114 in the direction from down to up (i.e., the direction from the touch sensor E to the touch sensor B) is sensed, the touch sensing unit 120 may transfer a user input interrupt signal corresponding to the “Drag & Flick” gesture 601 to the data processor 150. The data processor 150 may control an application being executed by the mobile terminal 100 according to the user input interrupt signal. If a “Drag & Flick” gesture is sensed, the data processor 120 may perform at least one of volume control and turning the page according to an application being executed in the mobile terminal. The “Drag & Flick” gesture 601 may be referred to as a volume up short key gesture.

For example, if an audio play application is being executed, the data processor 150 may perform volume up operation if a “Drag & Flick” gesture, such as “Drag & Flick” gesture 601 of FIG. 6, is sensed. If a “Drag & Flick” gesture, such as “Drag & Flick” gesture 601 of FIG. 6, is sensed and if the data processor 150 is executing an application for a web page or a page of an electronic book, the data processor 150 may perform, for example, an operation of turning the page to the previous page. A “Drag & Flick” gesture input may result in various operations according to an application being executed by the data processor 150.

The touch sensing unit 120 may determine whether a touch input satisfies wrong operation conditions for volume up short key in order to detect a wrong operation related to a volume up short key. A first wrong operation condition for volume up short key may be a condition in which at least one of the touch sensor A, the touch sensor B, and the touch sensor C is pressed when the touch sensor E is pressed, a second wrong operation condition may be a condition in which the touch sensor A is pressed simultaneously when the touch sensor C and the touch sensor D are pressed, and a third wrong operation condition may be a condition in which three or more touch sensors are simultaneously pressed.

Referring to the right part 620 of FIG. 6, if a “Drag & Flick” gesture 602 of dragging an object (i.e., finger, stylus, etc.) against the touch sensor B, the touch sensor C, the touch sensor D, and the touch sensor E of the second input area 114 in the direction from up to down (i.e., in the direction from the touch sensor B to the touch sensor E) is sensed, the touch sensing unit 120 may provide a user input interrupt signal corresponding to the “Drag & Flick” gesture 602 to the data processor 150. The data processor 150 may control an application being executed by the mobile terminal 100 according to the user input interrupt signal. The “Drag & Flick” gesture 602 may be referred to as a volume down short key gesture.

For example, if an audio play application is being executed, the data processor 150 may perform volume down operation if a “Drag & Flick” gesture, such as “Drag & Flick” gesture 602 of FIG. 6 is sensed. If a “Drag & Flick” gesture, such as “Drag & Flick” gesture 602 of FIG. 6, is sensed when the data processor 150 is executing an application for a web page or a page of an electronic book, the data processor 150 may perform, for example, an operation of turning the page to the next page. A “Drag & Flick” gesture input may result in various operations according to an application being executed by the data processor 150.

A first wrong operation condition for volume down short key may be a condition in which at least one of the touch sensor D and the touch sensor E is pressed when the touch sensor B is pressed, a second wrong operation condition may be a condition in which the touch sensor B is pressed simultaneously when the touch sensor B and the touch sensor C are pressed, and a third wrong operation condition may be a condition in which three or more touch sensors are simultaneously pressed.

FIG. 7 illustrates a touch input to control volume according to an exemplary embodiment of the present invention. Although FIG. 7 will be described with reference to FIG. 1, aspects of the exemplary embodiments are not limited thereto.

Referring to the right part 710 of FIG. 7, if a “Drag & Stop” gesture 701 of dragging an object (i.e., finger, stylus, etc.) against the touch sensor B, the touch sensor C, the touch sensor D, and the touch sensor E of the second input area 114 in the direction from down to up (i.e., in the direction from the touch sensor E to the touch sensor B) is sensed, the touch sensing unit 120 may provide a user input interrupt signal corresponding to the “Drag & Stop” gesture 701 to the data processor 150. The “Drag & Stop” gesture may refer to a touch input maintained longer than a predetermined time at a location where the drag gesture is terminated. A change in capacitance of the touch sensor at the location where the drag gesture is terminated may be sensed for a longer period than a predetermined period of time. If a “Drag & Stop” gesture is sensed, the data processor 150 may perform at least one of volume control and a page turning operation at a higher speed than when normal operation. The “Drag & Stop” gesture 701 may be referred to as a volume up long key gesture. The “Drag & Stop” gesture may refer to a touch input is maintained longer than a predetermined period of time at a location where the drag gesture is terminated. A change in capacitance of the touch sensor at the location where the drag gesture is terminated may be sensed for a longer period than a predetermined period of time. If a “Drag & Stop” gesture is sensed, the data processor 150 may perform at least one of volume control and a page turning operation at a higher speed than when normal operation. The “Drag & Stop” gesture 701 may be referred to as a volume up long key gesture. However, aspects of the invention are not limited thereto, such that “Drag & Stop” gesture may be used to perform other operations, for example, opening an application or file. Further, the speed of operation may be based on a type of application that may be operated at the time such gesture is sensed.

For example, if an audio play application is being executed, the data processor 150 may perform volume up operation at a high speed if a “Drag & Stop” gesture, such as “Drag & Stop” gesture 701 of FIG. 7, is sensed. If a “Drag & Stop” gesture, such as “Drag & Stop” gesture 701 of FIG. 7, is sensed when the data processor 150 is executing an application for a web page or a page of an electronic book, the data processor 150 may perform an operation of turning the page to the previous page at a high speed. A “Drag & Stop” gesture input may result in various operations according to an application being executed by the data processor 150.

Referring to the right part 720 of FIG. 7, if a “Drag & Stop” gesture 702 of dragging an object (i.e., finger, stylus, etc.) against the touch sensor B, the touch sensor C, the touch sensor D, and the touch sensor E of the second input area 114 in the direction from up to down (i.e., in the direction from the touch sensor B to the touch sensor E) is sensed, the touch sensing unit 120 may provide a user input interrupt signal corresponding to the “Drag & Stop” gesture 702 to the data processor 150. The data processor 150 may control an application being executed according to the user input interrupt signal. The “Drag & Stop” gesture 702 may be referred to as a volume down long key gesture.

For example, if an audio play application is being executed, the data processor 150 may perform volume down operation at a high speed if a “Drag & Stop” gesture, such as “Drag & Stop” gesture 702 of FIG. 7, is sensed. If a “Drag & Stop” gesture, such as “Drag & Stop” gesture 702 of FIG. 7, is sensed when the data processor 150 provides a web page or a page of an electronic book, the data processor 150 may perform operation of turning the page to the next page at a high speed. A “Drag & Stop” gesture input may result in various operations according to an application being executed by the data processor 150.

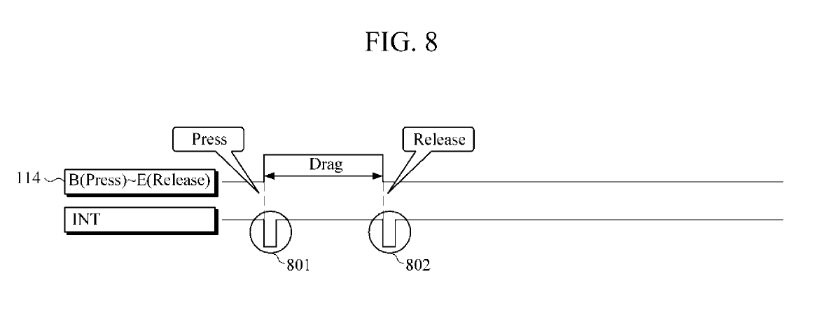

FIG. 8 is a timing diagram illustrating user input interrupt signal pulses of a touch sensing unit according to an exemplary embodiment of the present invention. FIG. 8 is a timing diagram illustrating user input interrupt signal pulses of a touch sensing unit according to a volume short key and a volume long key. Although FIG. 8 will be described with reference to FIG. 1, aspects of the exemplary embodiments are not limited thereto.

If the touch sensing unit 120 transmits a user input interrupt signal to the data processor 150, the data processor 150 may distinguish a long key from a short key when performing volume up/down operation using the following method.

At a press start time when a user starts to press an object to the touch sensor at a location at which dragging with respect to the touch sensor B, the touch sensor C, the touch sensor D, and the touch sensor E of the second input area 114, the touch sensing unit 120 may send a first interrupt signal 801 to the data processor 150. At a press release time when the user removes the object from the touch sensor at a location at which the dragging is terminated, the touch sensing unit 120 may send a second interrupt signal 802 to the data processor 150.

In order to distinguish a “Drag & Flick” gesture from a “Drag & Stop” gesture upon volume up and volume down operations, the data processor 150 may use a dragging time interval which is a time interval between the first interrupt signal 801 and the second interrupt signal 802 The first interrupt signal 801 may corresponds to a press start time when dragging with respect to the touch sensor B, the touch sensor C, the touch sensor D, and the touch sensor E of the second input area 114 begins, and the second interrupt signal 802 may corresponds to a press release time when the user removes his or her finger from the touch sensor at a location at which the dragging is terminated. If it is determined that a dragging time interval of a certain touch input is equal to or longer than a reference time interval (for example, 500 ms), the data processor 150 may recognize the touch input as a long key input, and if it is determined that the dragging time interval is shorter than the reference time interval, the data processor 150 may recognize the touch input as a short key input.

If the first interrupt signal 801 is received, the data processor 150 may access a second address of the register 122 of the touch sensing unit 120 to read a second register value from the second address, and if the second interrupt signal 802 is received, the data processor 150 may detect a time interval between the first interrupt signal 801 and the second interrupt signal 802, which corresponds to a dragging time interval. The data processor 150 may determines a touch gesture based on the dragging time interval and gesture state information which the second register value may represent.

If the time interval between the first interrupt signal 801 and the second interrupt signal 802 is shorter than a reference time interval and the second register value represents a volume up gesture, the data processor 150 may recognize the corresponding touch gesture as a volume up short key. If the time interval between the first interrupt signal 801 and the second interrupt signal 802 is shorter than the reference time interval and the second register value represents a volume down gesture, the data processor 150 may recognize the corresponding touch gesture as a volume down short key. If the time interval between the first interrupt signal 801 and the second interrupt signal 802 is equal to or longer than the reference time interval and the second register value represents a volume up gesture, the data processor 150 may recognize the corresponding touch gesture as a volume up long key. If the time interval between the first interrupt signal 801 and the second interrupt signal 802 is equal to or longer than the reference time interval and the second register value represents a volume down gesture, the data processor 150 may recognize the corresponding touch gesture as a volume down long key.

The above description relates to a situation where the touch input is received on the touch sensor E and dragged upwards to the touch sensor B, or when from the touch input is received on the touch sensor B and dragged downwards to the touch sensor E. When such touch inputs are sensed or detected, a gesture corresponding to a volume up or volume down operation may be recognized. However, if a sensed touch input or drag motion satisfies a predetermined threshold gesture rate for recognition, the corresponding touch input or drag motion may be recognized as a normal drag gesture. The gesture rate may be set to a ratio (e.g. 80%) of touch sensors that generate corresponding touch signals for the touch sensors that detects touch input that may be dragged thereon. Accordingly, a drag gesture from the touch sensor D to the touch sensor B may be recognized as a volume up gesture, and a drag gesture from the touch sensor C to the touch sensor E may be recognized as a volume down gesture. However, aspects of the invention are not limited thereto, such that one or more touch sensors may be operated independently without the use of a drag motion or gesture to perform one or more operations of the terminal 100. Further, various combinations of touch sensors may be operated simultaneously to perform one or more operations.

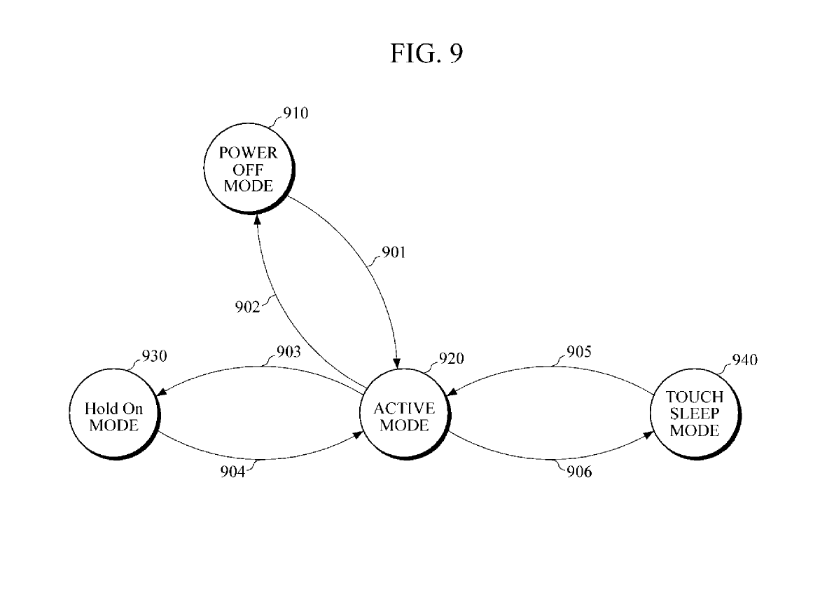

FIG. 9 illustrates a state model of a mobile terminal according to an exemplary embodiment of the present invention. Although FIG. 9 will be described with reference to FIG. 1, aspects of the exemplary embodiments are not limited thereto.

The operation modes of the mobile terminal 100 include a power off mode 910, an active mode 920, a hold on mode, and a touch sleep mode 940.

Referring to FIG. 1 and FIG. 9, the power off mode 910 may be a power off state in which no power is supplied to the mobile terminal 100. In the power off mode 910, the touch sensing unit 120 may be in powered on state, and the touch sensing unit 120 may activate the second input area 114 which may be a power key input area. If a power on gesture is sensed in the power off mode 910, the power on mode may be converted into the active mode 920, as illustrated by an arrow 901 of FIG. 9. If a power off gesture is sensed in the active mode 920, the active mode 920 may be converted into the power off mode 910, as illustrated by an arrow 902.

The active mode 920, the hold on mode 930, and the touch sleep mode 940 are modes of the mobile terminal 100 that is in a power on state.

The active mode 920 represents a state in which power may be supplied to the mobile terminal 100, both the touch panel 110 and the touch screen (not shown) are activated so that functions of the mobile terminal 110 may operate normally, user inputs may be received, and applications may be executed according to the user inputs.

In the hold on mode 930, some functions of the mobile terminal 100 may be deactivated because no power is supplied to the corresponding modules of the mobile terminal 100. In the hold on mode 930, the first input area 112 of the touch panel 110 may be activated and the second input area 114 may be deactivated so that only user inputs of touching the first input area 112 may be sensed. If a hold off gesture (i.e., Short Key Touch & Drag) is sensed in the hold on mode 930, the hold on mode 930 may be converted into the active mode 920, as illustrated by an arrow 904. If a hold on gesture is sensed in the active mode 920, the active mode 920 may be converted into the hold on mode 930, as illustrated by an arrow 903.

The touch sleep mode 940 may be a mode which the touch sensing unit 120 enters, as illustrated by an arrow 906, if no user touch input onto the touch panel 110 is sensed for a reference time interval in the active mode 920. If the mobile terminal 100 is in the touch sleep mode 940, the state of the mobile terminal 100 may be the same as when the mobile terminal 100 is in the active mode, except for the state of the touch sensing unit 120. The touch sleep mode 940 may be a mode for reducing power consumption of the touch sensing unit 120 if no touch input is sensed for a reference time interval in the active mode 920. If a touch gesture received on the touch panel 100 is sensed in the touch sleep mode 940, the touch sleep mode 940 may be converted into the active mode 920, as illustrated by an arrow 905.

The data processor 150 may operate according to the power off mode 910, the active mode 920, and the hold on mode 930, and whenever the mobile terminal 100 enters each mode, the data processor 150 may set a register value corresponding to the mode as a first register value and write the first register value in the first address of the register 212 of the touch sensing unit 120. For example, if the mobile terminal 100 enters the power off mode 910, the data processor 150 may write a value 0×F0 as a first register value in the first address of the register 212 of the touch sensing unit 120, and if the mobile terminal 100 enters the active mode 920, the data processor 150 may write a value 0×F8 as state information in the first address of the register 212.

The touch sensing unit 120 may control the touch panel 110 according to the first register value. In the power off mode 910 and the hold on mode 930, the first input area 112 of the touch panel 110 is activated, and in the active mode 920, the first input area 112 and second input area 114 of the touch panel 110 are activated. In the touch sleep mode 940, both the first input area 112 and second input area 114 are activated while controlling the touch panel 110 such that the touch panel 110 may consume less power than in the active mode 920.

If a user's unintended touch key is input and if another touch input is not sensed for a reference time interval (for example, 5 seconds) although the mode of the mobile terminal 100 may have been converted, the mobile terminal 100 may return to a previous mode. For example, if a touch input is sensed in the touch sleep mode 940 and the mobile terminal 100 enters the active mode 920, if another touch input is not sensed, the mobile terminal 100 may return to the touch sleep mode 940. Similarly, the operation may be applied in the same manner to when the mobile terminal 100 is in the hold on mode 930 and the power off mode 910.

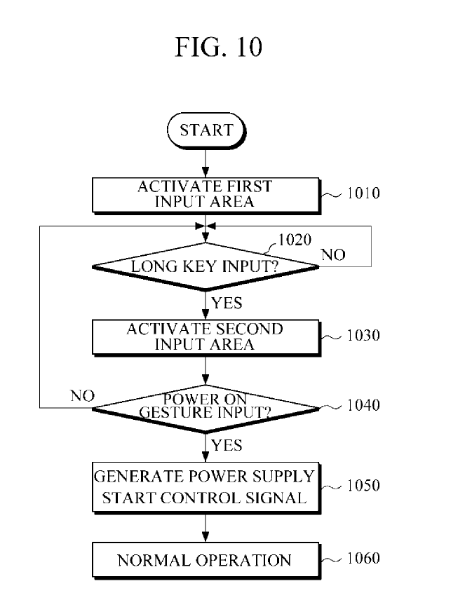

FIG. 10 is a flowchart of a method for operating a mobile terminal according to an exemplary embodiment of the present invention. FIG. 10 is a flowchart of a method for operating a mobile terminal according to a power control gesture. Although FIG. 10 will be described with reference to FIG. 1, aspects of the exemplary embodiments are not limited thereto.

In operation 1010, a first input area 112 of the mobile terminal 100 is activated. If the mobile terminal 100 is in the power off state, the first input area 112 of the touch panel 110 may be activated.

In operation 1020, the touch sensing unit 120 determines if a long key input is received on the first input area 112. If a long key is input through the first input area 112 such that a touch sensed signal is maintained for a first time interval in operation 1020, in operation 1030, the touch sensing unit 120 activates the second input area 114.

In operation 1040, the touch sensing unit 120 determines if a power on gesture is received on the second input area 114. If a power on gesture of touching the second input area 114 is sensed such that a drag touch sensed signal is generated if the second input area 114 is in the activated state. If a power on gesture is input, in operation 1050, the touch sensing unit 120 generates a power supply start control signal to supply power to the mobile terminal 100. The power controller 130 supplies power to the mobile terminal 100 according to the power supply start control signal, and in operation 1060, the mobile terminal 100 may operate normally.

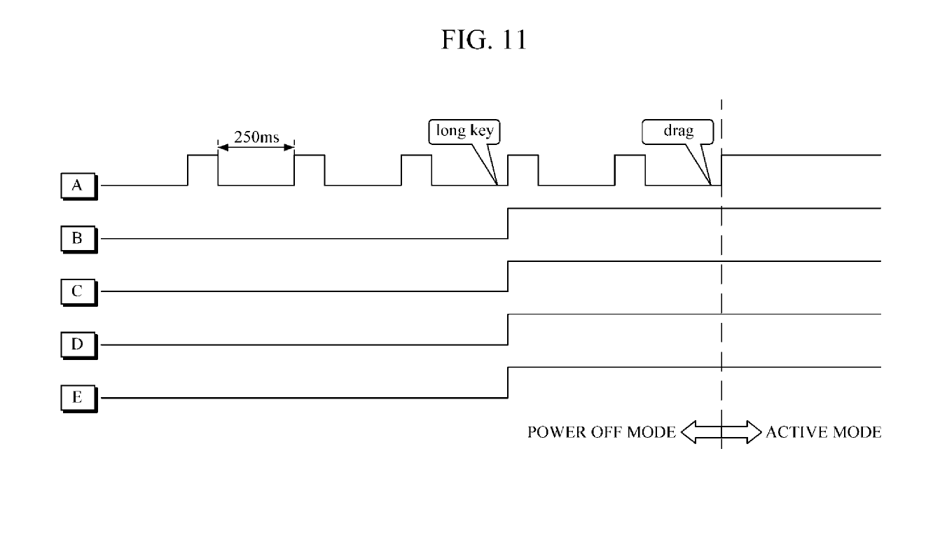

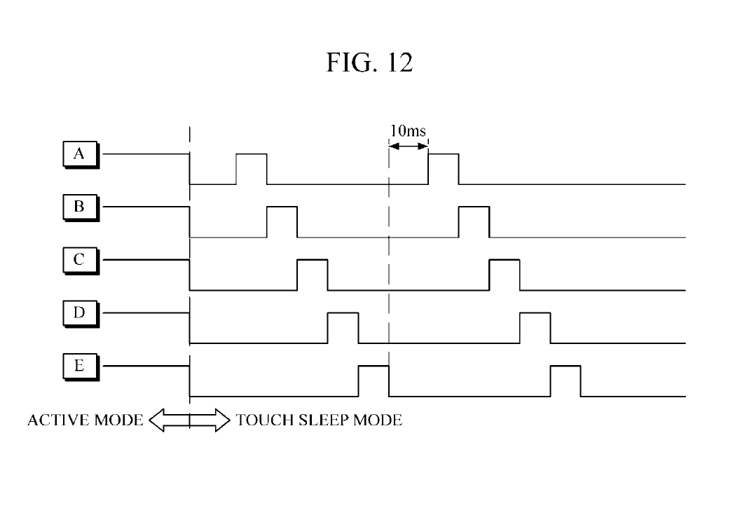

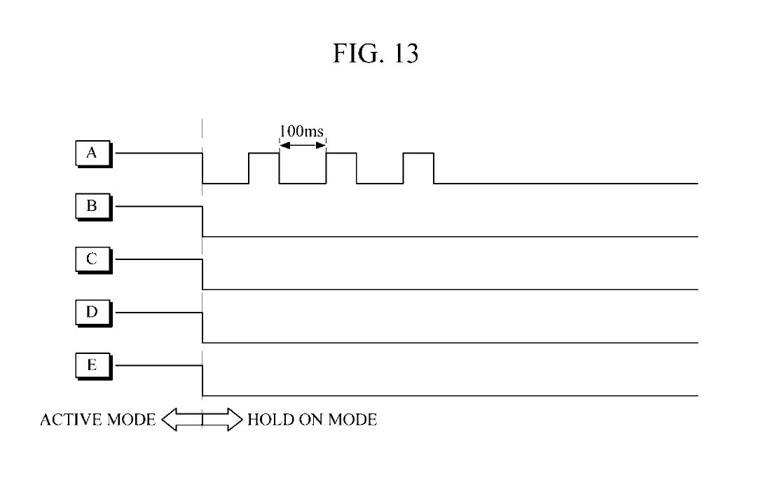

Hereinafter, a method in which the touch sensing unit 120 controls the touch panel 110 to sense a touch gesture will be described with reference to FIG. 11, FIG. 12, and FIG. 13. The touch sensing unit 120 may control individual touch sensors included in the touch panel 110 in order to sense a touch gesture with respect to the touch panel 110 according to an operation mode of the mobile terminal 100.

As described above with reference to FIG. 3, the touch sensor A is included in the first input area 112 of the touch panel 110, and the touch sensor B, the touch sensor C, the touch sensor D, and the touch sensor E are included in the second input area 114 of the touch panel 110. The waveforms with respect to the first input area 112 and second input area 114, as illustrated in FIG. 4, FIG. 5, and FIG. 8, illustrate changes of touch sensed signals that the touch sensing unit 120 receives from the touch panel 110, whereas waveforms illustrated in FIG. 11, FIG. 12, and FIG. 13 represent the waveforms of activation signals that the touch sensing unit 120 use to control the touch sensor A, the touch sensor B, the touch sensor C, the touch sensor D, and the touch sensor E.

The touch sensing unit 120 may control the touch sensor A, the touch sensor B, the touch sensor C, the touch sensor D, and the touch sensor E according to the power off mode 910, the active mode 920, and the hold on mode 930, related to the operation of the mobile terminal 100, and according to the touch sleep mode 940 which is an operation mode related to the touch sensing unit 120, as described above with reference to FIG. 9, and may thereby reduce power consumption and sense touch gestures. The touch sensing unit 120 may provide activation signals to activate the touch sensor A, the touch sensor B, the touch sensor C, the touch sensor D, and the touch sensor E to the touch sensor A, the touch sensor B, the touch sensor C, the touch sensor D, and the touch sensor E through the I/O 1, the I/O 2, the I/O 3, the port I/O 4, and the I/O 5, respectively, as illustrated in FIG. 1.

FIG. 11 is a timing diagram of waveforms of activation signals to sense a touch according to an exemplary embodiment of the present invention. FIG. 11 is a timing diagram of waveforms of activation signals to sense a touch in a power off mode and an active mode. Although FIG. 11 will be described with reference to FIG. 1 and FIG. 9, aspects of the exemplary embodiments are not limited thereto.

Referring to FIG. 1, FIG. 9, and FIG. 11, in the power off mode 910, power is not supplied to the mobile terminal 100, except for the touch sensing unit 120. If a power on gesture, such as “Long Key Touch & Drag,” is sensed in the power off mode 910, the power off mode 910 may be converted into the active mode 920.

In the power off mode 910, the touch sensing unit 120 provides to the touch sensor A of the first input area 112 an activation signal to activate the touch sensor A of the first input area 112, and the touch sensor B, the touch sensor C, the touch sensor D, and the touch sensor E of the second input area 114 are deactivated. An activation signal having a reference first time interval, as illustrated in FIG. 11, may be provided to the touch sensor A. For example, the first time interval may be 250 ms.

If a long key is sensed through the first input area 112 and has a time interval longer than a first time interval while any touch onto the first input area 112 is monitored according to the activation signal provided to the touch sensor A in the power off mode 910, the touch sensing unit 120 may supply activation signals to the touch sensor B, the touch sensor C, the touch sensor D, and the touch sensor E of the second input area 114 to activate the second input area 114. The touch sensing unit 120 may continue to supply control signals with a reference magnitude to the touch sensor B, the touch sensor C, the touch sensor D, and the touch sensor E such that the touch sensor B, the touch sensor C, the touch sensor D, and the touch sensor E of the second input area 114 are turned on to sense touches thereon.

If a drag gesture is sensed on the second input area 114 activated after the long key is sensed on the first input area 112, the mobile terminal 100 may enter the active mode 920, and the touch sensing unit 120 may supply an activation signal to the touch sensor A of a reference magnitude. In the active mode 920 of the mobile terminal 100, activation signals with reference magnitudes may be supplied to the touch sensor A, the touch sensor B, the touch sensor C, the touch sensor D, and the touch sensor E of the touch panel 110, such that the touch sensor A, the touch sensor B, the touch sensor C, the touch sensor D, and the touch sensor E are turned on to sense touch gestures.

FIG. 12 is a timing diagram of waveforms of activation signals according to an exemplary embodiment of the present invention. FIG. 12 is a timing diagram of the waveforms of activation signals to sense a touch if the mode of a mobile terminal is converted from the active mode to the touch sleep mode according to an exemplary embodiment of the present invention. Although FIG. 12 will be described with reference to FIG. 1 and FIG, 9, aspects of the exemplary embodiments are not limited thereto.

As described above with reference to FIG. 9, if a user's touch input onto the touch panel 110 is not sensed for a reference time interval (for example, 3 seconds) in the active mode 920, the touch sensing unit 120 may enter the touch sleep mode 940. The touch sensing unit 120 may use an internal timer (not shown) to determine whether a user's touch input is sensed for a reference time interval in the active mode 920.

In the touch sleep mode 940, the touch sensing unit 120 may activate the touch sensor A, the touch sensor B, the touch sensor C, the touch sensor D, and the touch sensor E of the touch panel 110, while consuming less power than in the active mode 920. If the touch sensing unit 120 enters the touch sleep mode 940 from the active mode 920, in which the touch sensing unit 120 supplies activation signals of reference magnitudes to the touch sensor A, the touch sensor B, the touch sensor C, the touch sensor D, and the touch sensor E of the touch panel 110, as illustrated in FIG. 12, the touch sensing unit 120 may supply periodical signals to the touch sensor A, the touch sensor B, the touch sensor C, the touch sensor D, and the touch sensor E. The periodic signals may have reference periods which may be offset from each other sequentially in the touch sensors of the first input area 112 and second input area 114. For example, if a reference time interval (for example, 10 ms) elapses after the periodical signal is supplied to the touch sensor E, to which the activation signal has been supplied, the periodical signals, may be supplied sequentially to the touch sensor A, the touch sensor B, the touch sensor C, the touch sensor D, and the touch sensor E.

In the touch sleep mode 940, unlike the active mode 920 in which activation signals continue to be supplied to the touch sensor A, the touch sensor B, the touch sensor C, the touch sensor D, and the touch sensor E, periodical signals are sequentially supplied to the touch sensor A, the touch sensor B, the touch sensor C, the touch sensor D, and the touch sensor E, and accordingly, the touch sensing unit 120 may monitor touch gestures, while consuming less power than in the active mode 920.

A method of sequentially supplying periodical signals having reference periods to the touch sensor A, the touch sensor B, the touch sensor C, the touch sensor D, and the touch sensor E may be referred to as a scanning method. The period of each periodical signal and a time interval consumed to supply the periodical signals to the touch sensor A, the touch sensor B, the touch sensor C, the touch sensor D, and the touch sensor E may be arbitrarily set.

FIG. 13 is a timing diagram of waveforms of activation signals according to an exemplary embodiment of the present invention. FIG. 13 is a timing diagram of the waveforms of activation signals to sense if the mode of a mobile terminal is converted from an active mode to a hold on mode according to an exemplary embodiment of the present invention. Although FIG. 13 will be described with reference to FIG. 1 and FIG, 9, aspects of the exemplary embodiments are not limited thereto.

As described above with reference to FIG. 9, if a hold on gesture, such as “Short Key Touch & Drag,” is sensed in the active mode 920, the mobile terminal 100 enters the hold on mode 930. If a hold off gesture, such as “Short Key Touch & Drag,” is sensed in the hold on mode 930, the mobile terminal 100 may enter the active mode 920. In the hold on mode 930, the touch sensor A of the first input area 112 is activated to sense an input of a hold off gesture. In the hold on mode 930, the touch sensing unit 120 may provide the touch sensor A with a periodical signal having a second time interval (for example, 100 ms) shorter than a first time interval that is provided in the power off mode 910, as an activation signal, and the touch sensing unit 120 may deactivate the touch sensor B, the touch sensor C, the touch sensor D, and the touch sensor E of the second input area 114.

According to exemplary embodiments, by controlling a touch panel to sense a touch using different methods according to the operation modes of a mobile terminal and the operation modes of a touch sensing unit, it may be possible to reduce power consumption of the mobile terminal.

According to exemplary embodiments, a touch-based power key and volume keys, instead of mechanical switches, may be configured on the outer surface of the mobile terminal, it may be possible to improve a design of a mobile terminal and achieve high reliability in operation.

The present invention may be implemented as computer readable codes in a non-transitory computer readable record medium. The non-transitory computer readable record medium includes all types of record media in which computer readable data are stored. Examples of the non-transitory computer readable record medium include a ROM, a RAM, a CD-ROM, a magnetic tape, a floppy disk, and an optical data storage. In addition, the non-transitory computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a touch screen to receive inputs in a power on state;
a touch panel to detect a touch gesture, the touch panel being separate from the touch screen; and
a touch sensing unit to perform at least one of power on the mobile terminal, power off the mobile terminal, adjust a volume of the mobile terminal, hold on the mobile terminal, or hold off the mobile terminal according to the touch gesture and a mode of the mobile terminal.

2. The mobile terminal of claim 1, wherein the touch panel comprises:
a first input area including a first touch sensor to receive a first touch gesture; and
a second input area including a second touch sensor to receive a second touch gesture,
wherein the touch panel generates a touch sensed signal according to the received touch gesture and transfers the touch sensed signal to the touch sensing unit.

3. The mobile terminal of claim 1, wherein the touch sensor is at least one of a capacitive touch sensor, a resistive touch sensor, and a pressure sensor.

4. The mobile terminal of claim 1, further comprising:
a power controller to supply power to the mobile terminal according to a power control signal received from the touch sensing unit.

5. The mobile terminal of claim 1, further comprising:
a data processor to control operation of the mobile terminal according to a user input interrupt signal received from the touch sensing unit.

6. The mobile terminal of claim 1, wherein the touch sensing unit determines if the touch gesture is at least one of a long key input, a short key input, a long key touch and drag gesture, and a short key touch and drag.

7. The mobile terminal of claim 6, wherein if the mobile terminal is in a power on state and if the touch gesture is a long key touch and drag gesture, the mobile terminal calls an operation of the mobile terminal.

8. The mobile terminal of claim 7, wherein the operation of the mobile terminal is one of a volume up operation, a volume down operation, a hold on operation, and a hold off operation.

9. The mobile terminal of claim 6, wherein the long key input has a time interval greater than or equal to 1 second.

10. The mobile terminal of claim 6, wherein the short key input has a time interval less than 1 second.

11. The mobile terminal of claim 2, wherein, if the mobile terminal is in a power off mode, the first sensor is powered on, and the second sensor is powered off.

12. The mobile terminal of claim 11, wherein the first sensor receives an activation signal having a first time interval.

13. The mobile terminal of claim 11, wherein, if a power on gesture is received as the touch gesture, the second sensor is powered on and receives a control signal of a reference magnitude.

14. The mobile terminal of claim 2, wherein, if the mobile terminal is in an active mode, the first sensor is powered on, and the second sensor is powered on.

15. The mobile terminal of claim 14, wherein, if a touch gesture is not received within a reference time interval, the mobile terminal enters a touch sleep mode and the first sensor and the second sensor receive periodic signals having a first period.

16. The mobile terminal of claim 1, wherein, if the mobile terminal is in a hold on mode, the first sensor is powered on, and the second sensor is powered off.

17. The mobile terminal of claim 16, wherein the first sensor receives an activation signal having a second time interval.

18. The mobile terminal of claim 11, wherein, if the touch gesture is a long key input, the second sensor is powered on, and, if a power on gesture is received in the first sensor and the second sensor, the touch sensing unit activates the touch screen.

19. A method of operating a mobile terminal including a touch panel and a touch screen, the method comprising:
activating a first input area of the touch panel to receive a first touch gesture, the touch panel being separate from the touch screen;
activating a second input area of the touch panel to receive a second touch gesture if the first touch gesture is received;
determining if a second touch gesture is received; and
generating a power supply start control signal to power on or power off the mobile terminal according to the first touch gesture and the second touch gesture.

20. The method of claim 19, further comprising, if the mobile terminal is in a power on state, generating a user input interrupt signal to control the touch screen of the mobile terminal.

21. The method of claim 19, further comprising, if the mobile terminal is in a power on state and if the touch pad receives the first touch gesture, calling an operation of the mobile terminal.

22. The method of claim 21, wherein if the touch gesture is a long key input, the second sensor is powered on, and, if a power on gesture is received in the first sensor and the second sensor, the touch sensing unit activates the touch screen.

23. The method of claim 21, wherein the operation is one of a volume up operation, a volume down operation, a hold on operation, and a hold off operation.

24. The method of claim 22, wherein the long key input has a time interval greater than or equal to 1 second.

25. The method of claim 22, wherein the short key input has a time interval less than 1 second.

26. A method of operating a mobile terminal including a touch panel, the method comprising:
receiving a first touch gesture in the touch panel;
determining whether to power on the mobile terminal according to the first touch gesture and a mode of the mobile terminal; and
generating a signal to provide power to the mobile terminal according to the determination.

27. A mobile terminal, comprising:
a touch screen to receive inputs in a power on state;
a touch panel to detect a touch gesture, the touch panel being separate from the touch screen; and
a touch sensing unit to perform at least one operation of the mobile terminal.

28. The mobile terminal of claim 27, wherein the operation of the mobile terminal is at least one of power on the mobile terminal, power off the mobile terminal, adjust a volume of the mobile terminal, hold on the mobile terminal, or hold off the mobile terminal according to the touch gesture and a mode of the mobile terminal.
